(19) United States
(12) Patent Application Publication
(10) Pub. No.: US 2025/0050771 A1
(43) Pub. Date: Feb. 13, 2025

(54) EV CHARGING SYSTEM WITH ELECTRIC VEHICLE CHARGING MARKER

(71) Applicant: EVJAM LLC, Minneapolis, MN (US)

(72) Inventors: Steven DICKE, Minneapolis, MN (US); Gregg KROMREY, Hudson, WI (US)

(73) Assignee: EVJAM LLC, Minneapolis, MN (US)

(21) Appl. No.: 18/815,772

(22) Filed: Aug. 26, 2024

Related U.S. Application Data
(63) Continuation-in-part of application No. 18/801,508, filed on Aug. 12, 2024.
(60) Provisional application No. 63/534,399, filed on Aug. 24, 2023.
(60) Provisional application No. 63/531,992, filed on Aug. 10, 2023.
(60) Provisional application No. 63/531,996, filed on Aug. 10, 2023.
(60) Provisional application No. 63/532,000, filed on Aug. 10, 2023.
(60) Provisional application No. 63/534,396, filed on Aug. 24, 2023.

(51) Int. Cl. B60L 53/37

(52) U.S. Cl. CPC B60L 53/37

(57) ABSTRACT

One or more examples provide an electric vehicle charging system with a charging marker. The charging marker aids in locating an electric vehicle charging port for autonomous and hands free charging of the electric vehicle.

### CROSS-REFERENCE TO RELATED APPLICATION

This Non-Provisional Patent Application is a continuation-in part of U.S. Ser. No. 18/801,508, filed Aug. 12, 2024, which claims the benefit of the filing dates of U.S. Provisional Patent Application Ser. No. 63/531,992, filed Aug. 10, 2023, U.S. Provisional Patent Application Ser. No. 63/531,996, filed Aug. 10, 2023, U.S. Patent Provisional Application Ser. No. 63/532,000, filed Aug. 10, 2023, U.S. Patent Provisional Application Ser. No. 63/534,399, filed Aug. 24, 2023; and claims the benefit of the filing date of U.S. Patent Provisional Application Ser. No. 63/534,396, filed Aug. 24, 2023, all of which are incorporated by reference.

### TECHNICAL FIELD

The present disclosure relates generally to examples of electric vehicles and to devices for use with an electric vehicle, including electric vehicle batteries and electric vehicle charging systems and devices.

### BACKGROUND

Electric vehicles (EVs), such as automobiles (e.g., cars and trucks), motorcycles, all-terrain vehicles (ATVs), and electric bikes, for example, offer a quiet, clean, and more environmentally friendly option to gas-powered vehicles. Electric vehicles have electric powertrains which typically include a battery system, one or more electrical motors, each with a corresponding electronic power inverter (sometimes referred to as a motor controller), and various auxiliary systems (e.g., cooling systems). To ensure availability and to enhance user experience and ownership, EV charging should be convenient and timely.

For these and other reasons, there is a need for the present invention.

### SUMMARY

The present disclosure provides one or more examples of an electric vehicle charging system. In one example, the electric vehicle charging system includes a charging marker. The charging marker is associated with an electric vehicle to provide charging information relative to the electric vehicle. In one example, the charging marker provides the coordinate location of the electric vehicle charging port. In one example, the charging marker provides other charging information unique to the electric vehicle requesting a charge.

### BRIEF DESCRIPTION OF THE DRAWINGS

The Figures generally illustrate one or more examples of an electric vehicle and/or devices for use with an electric vehicle such as electric vehicle batteries or electric vehicle charging systems and devices. In particular, the Figures generally illustrate a charging plug implemented as a magnetic charging panel and a corresponding charging port of an electric vehicle, in accordance with examples of the present disclosure.

FIG. 1 is a block and schematic diagram generally illustrating an electric vehicle charging system having a charging plug system with concentrically arranged magnet and electrical surface contacts, in accordance with one example of the present disclosure.

FIGS. 2A-2C are block and schematic top, side, and bottom views of an EV charging plug and charging port, according to one example of the present disclosure.

FIG. 2D is a schematic wiring diagram of the charging system and charging plug, according to one example of the present disclosure.

FIG. 3 is a block and schematic cross-sectional diagram of an EV charging plug, according to one example of the present disclosure.

FIGS. 4A and 4B and block and schematic cross-sectional views of an EV charging port, according to one example of the present disclosure.

FIG. 5 is a block and schematic cross-sectional view of an EV charging plug and EV charging port, according to one example of the present disclosure.

FIG. 6 is a block and schematic cross-sectional diagram of an EV charging plug and EV charging port according to one example of the present disclosure.

FIG. 7 is a block and schematic diagram of a hands-free EV charging system having an EV charging plug and EV charging port, according to one example of the present disclosure.

FIG. 8 is a block and schematic diagram illustrating portions of an EV charging plug and EV charging port, according to one example of the present disclosure.

FIGS. 9A and 9B are block and schematic side and front views of portions of a hands-free EV charging system, according to one example of the present disclosure.

FIG. 9 is a block and schematic diagram of a hands-free EV charging system having a EV charging plug and EV charging port, according to one example of the present disclosure.

FIG. 10 is the block and schematic diagram of a hands-free EV charging system having a EV charging plug and EV charging port, according to one example of the present disclosure.

FIG. 11 is a block and schematic diagram of a transport track layout for a hands-free EV charging system, according to one example of the present disclosure.

FIG. 12 is a schematic diagram of a transport track layout for a hands-free EV charging system, according to one example of the present disclosure.

FIG. 13 is a diagram illustrating one example charging station.

FIG. 14 is a diagram illustrating another charging station example.

FIG. 15 is a block diagram illustrating one example of charging station having a positioning system.

FIG. 16 is a side view illustrating one example of a charging station with a charging arm electrically coupled to an electric vehicle charging port.

FIG. 17 is a top view of a charging arm electrically coupled to a charging port of FIG. 16.

FIG. 18 is a diagram illustrating one example of a charging station including a location system for determining the exact location of an electric vehicle charging port.

FIG. 19 is a diagram illustrating one example of a charging marker location device including the operation of a scanner.

FIG. 20 is a flow diagram illustrating one example of a method of charging an electric vehicle using a charging marker.

### DETAILED DESCRIPTION

In the following detailed description, reference is made to the accompanying drawings which form a part hereof, and in which are shown by way of illustration specific examples in which the disclosure may be practiced. Additional and/or alternative features and aspects of examples of the present technology will become apparent from the following description and the accompanying drawings. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

Electric vehicles (EVs), such as automobiles (e.g., cars and trucks), motorcycles, all-terrain vehicles (ATVs), and electric bikes, for example, offer a quiet, clean, and more environmentally friendly option to gas-powered vehicles. Electric vehicles have electric powertrains which typically include a battery system, one or more electrical motors, each with a corresponding electronic power inverter (sometimes referred to as a motor controller), and various auxiliary systems (e.g., cooling systems).

To ensure availability and to enhance user experience and ownership, EV charging should be convenient and timely. Conventional EV charging systems typically employ a male-female type connection configuration between the charging plug of the EV charging station and the charging port of the EV. While such configuration makes a secure connection, such connections require accurate alignment between the male and female connectors (e.g., both planar and rotational alignment), and, as such, may sometime be difficult to make, such as in low light conditions or in inclement weather conditions, or for a person having physical limitations.

As will be described in greater detail herein, according to the present disclosure, examples are provided of an EV charging system including a charging plug having concentrically arranged surface contacts disposed on a surface of the charging plug (e.g., a planar surface) which are configured to align with and engage corresponding surface contacts of a charging port of an EV. In one example, the charging plug is a magnetic plug having one or more electromagnets and/or permanent magnets which are configured to secure the charging plug to the charging port of the EV during a charging operation. In examples, an EV may employ an integral charging point employing surface contacts corresponding to surface contacts of the charging plug. In other examples, an electric vehicle charging port adapter is provided which is configured to plug into a charging port of an EV and provides a surface contact configuration for use with the disclosed charging plug. In examples, the surface contacts of the charging plug and charging port are configured as concentrically arranged circular ring-like contacts which eliminate a need for rotational alignment between the charging plug and charging port and, thereby, simplify connectivity between the EV charging station and the EV charging port. As will be described in greater detail herein, simplifying the connectivity between the charging plug of the EV charging station and the EV charging port improves ease of use for drivers in general and for drivers with physical limitations in particular, and is advantageous to enable charging systems to provide hands-free EV charging (e.g., robotic charging systems where a driver does not need to leave the vehicle or even be present during a charging operation).

EV charging systems and devices as disclosed herein may be employed in residential locations (e.g., within a residential garage) and any suitable parking facility, such as parking ramps and surface parking lots, for example, and may be employed both as part of newly constructed parking facilities or adapted for use in existing parking facilities. The parking facility may be most any type of parking facility, such as a public parking facility (e.g., shopping centers), a corporate parking facility (e.g., associated with a business, such as manufacturing facility or a hotel), and a commercial parking facility (e.g., a pay facility)—any type of parking facility where EVs will be parked for extended time periods (e.g., for a half hour or more) while the drivers are occupied with other tasks (e.g., shopping, dining, attending a sporting event, working, etc.). In examples, the parking facility may include parking for both EVs and non-electric vehicles.

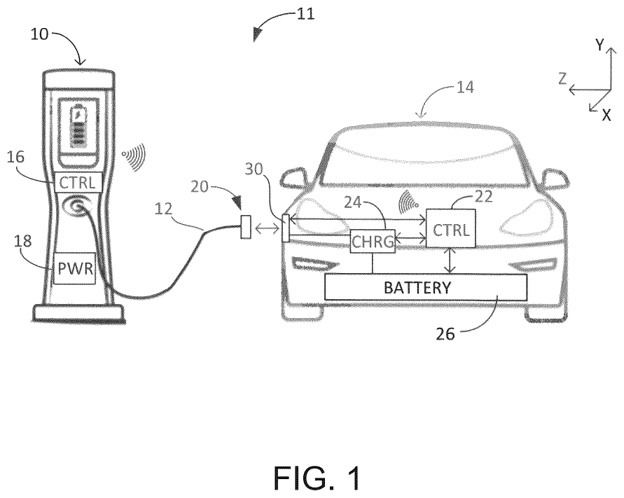

FIG. 1 is block and schematic diagram generally illustrating an EV charging station 10 employing a charging cable 12 with a magnetic charging plug 20 which, as will described in greater detail herein, includes a plurality of surface contacts which are configured to align with and engage/mate with corresponding surface contacts of a charging port 30 of an EV 14. In examples, as will be described herein, magnetic charging plug 20 is secured/locked to charging port 30 of EV 14 via magnetic contacts (e.g., electromagnets). In examples, the magnetic charging port 30 may be an integral part of EV 12 (i.e., manufactured therewith) or may comprise a magnetic port adapter which is insertable within an existing charging port of EV 14.

In examples, as will be described in greater detail herein, the surface contacts of charging plug 20 and charging port 30 are concentrically disposed (e.g., implemented as a plurality of concentric ring-like contacts) to eliminate a need to rotationally align charging plug 20 with charging port 30 when attaching charging plug 20 thereto (i.e., inherent rotational alignment therebetween).

In examples, EV charging station 10 includes a controller 16 and a controllable power supply 18 for providing charging power to EV 14. In examples, power supply 18 may be configured to provide a charging output to EV 14 having electrical characteristics which may be selected by EV 14 (e.g., AC, DC, voltage level, charge transfer rate, etc.). For example, in one case, charging station 10 may provide a 240 VAC charging output, and in another case, provide a 600 VDC charging output. In examples, communication between charging station 10 and EV 14 (e.g., control signals) may be via hardwired signal/control connections via cable 12 and charging plug 20 and/or wirelessly, as indicated at 17. In examples, EV 14 includes an EV control system 22 (e.g., controller(s), memory, sensors, etc.) and a charging system 24 (e.g., onboard battery charger and battery monitoring system) for charging rechargeable battery 26 via EV charging station 10.

In examples, EV charging station 10 with charging plug 20, and charging port 30 of EV 14 (including an EV controller 22) together represent an electric vehicle charging system 11 having a plug system (e.g., charging plug 20 and charging port 30) employing surface contacts as described herein. In examples, operation of the electric vehicle charging system 11 for charging of battery 26 may be controlled remotely via a computer, EV control system 22, charging station control system 16, and/or a user control application (e.g., via a phone). In some examples, charging plug 20 and charging port 30 may employ magnetic contacts (e.g., electromagnets) for securing charging plug 20 to charging port 30. In other examples, charging plug 20 and charging port may employ mechanical means for securing charging plug 20 to charging port 30 (e.g., a rotatable locking ring/cam mechanism).

In examples, by employing surface contacts which are concentrically disposed relative to one another, alignment and engagement of the contacts of charging plug 20 with the corresponding contacts of charging port 30 of EV 14 are simplified relative to conventional charging system employing traditional male/female type connectors. For example, by employing circular ring-like surface contacts, rotational alignment (i.e., about the z-axis in FIG. 1) is not necessary between charging plug 20 and EV charging port 30 when connecting EV 14 to charging station 10 to carry out a charging procedure and no alignment is required between male/female connectors as with conventional charging plugs.

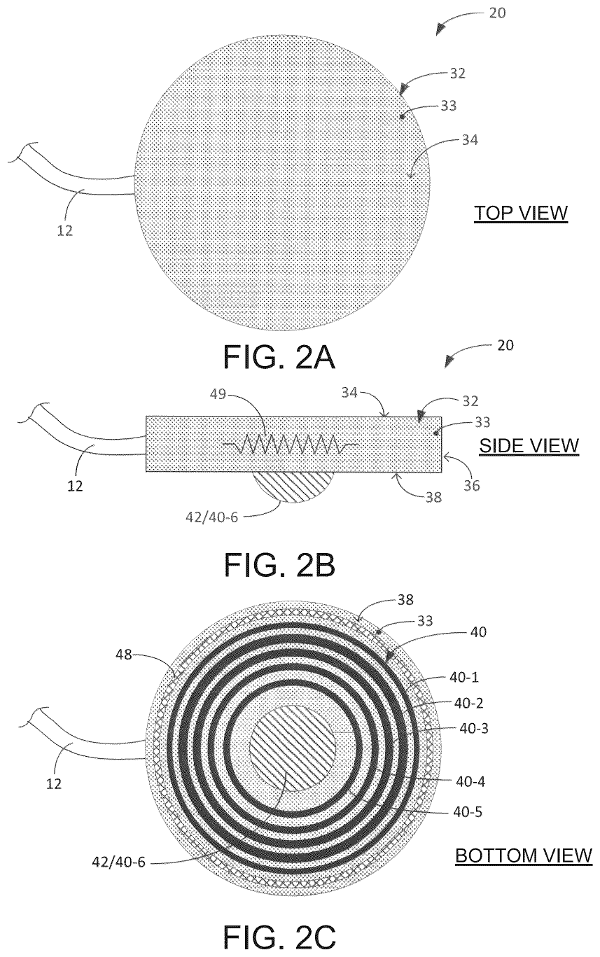

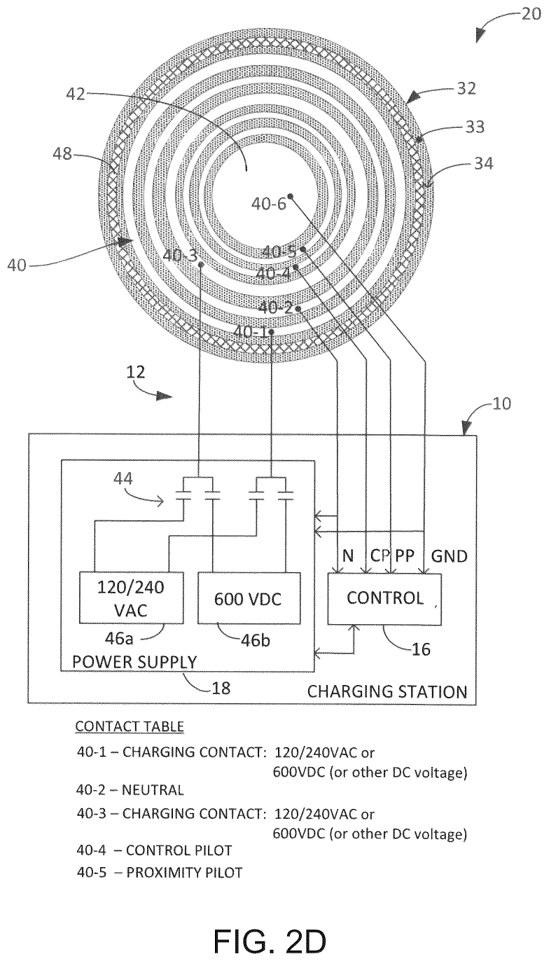

FIGS. 2A-2C generally illustrate top, side, and bottom views, respectively, of one example of a charging plug 20, in accordance with the present disclosure. In one example, charging plug 20 includes a main body 32 comprising an electrically insulating material 33 (e.g., a plastic mold compound) and having a top surface 34, a perimeter side surface 36, and a bottom surface 38, with power cable 12 extending therefrom to charging station 10. In one example, charging plug 20 includes a plug heater 49 disposed within main body 32 to prevent ice build-up on charging plug 20 in cold weather conditions. In one example, plug heater 49 comprises an electrical resistance heater which is powered from charging station 10.

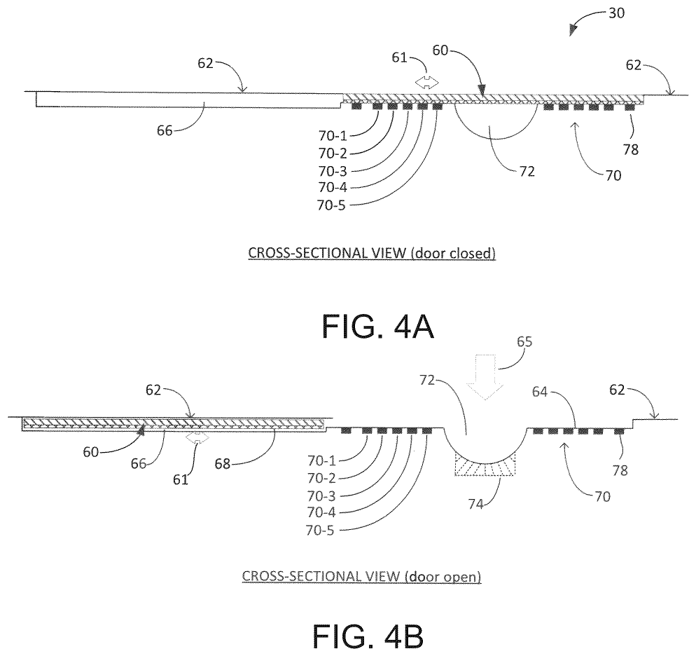

With reference to FIG. 2C, according to one example, charging plug 20 includes a plurality of circular, ring-like, contacts 40 which are disposed concentrically on bottom surface 38. In one example, as illustrated, contacts 40 include contacts 40-1 to 40-5. In other examples, there can be more or fewer contacts than that illustrated in FIG. 2C. In one example, charging plug 20 includes a plug alignment feature 42 for assisting in aligning charging plug 20 with the charging port 30 of EV 14. In one example, plug alignment feature 42 extends from bottom surface 38 and is configured to be received within a corresponding alignment indent 72 (see FIG. 4B) of charging port 30, where the alignment indent 72 has a shape which in the negative of the shape of the plug alignment feature 42. In one example, as illustrated, plug alignment feature 42 has a hemispherical, button-like shape which is configured to be received within a corresponding hemispherical alignment indent in charging port 30. In other examples, any number of other shapes may be employed. In one example, plug alignment feature 42 may also be configured as a plug contact 40-6, in addition to plug contacts 40-1 to 40-5.

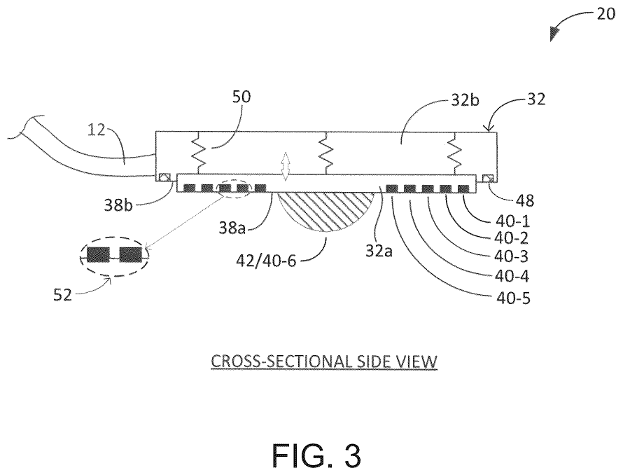

In one example, concentrically arranged contacts 40-1 to 40-5 are disposed flush with surface 38 of charging plug 20. In other examples, contacts 40-1 to 40-5 may extend incrementally beyond surface 38 (see FIG. 3). In examples, the mold compound 33 of main body 32 provides electrical insulation between contacts 40-1 to 40-5 (as well as 40-6), with adjacent contacts 40-1 to 40-6 being spaced apart to prevent electrical short-circuiting (e.g., electrical arcing) between adjacent contacts 40-1 to 40-6. The concentrically arranged contacts 40-1 to 40-5 are configured to deliver one or more charging voltages (e.g., 120/240 VAC, 600 VDC, etc.) as well as to provide communication pathways between charging station 10 and EV 14. In other examples, charging station 10 and EV 14 may communicate wirelessly with one another (e.g., Bluetooth, Bluetooth low-voltage).

In one example, electrical contacts 40-1 and 40-3 may be configured to carry charging voltages (e.g., 120/240 VAC, 600 VDC), electrical contact 40-2 may be configured as an electrical neutral contact, electrical contact 40-4 may be configured as a control pilot, and electrical contact 40-5 may be configured as a proximity pilot. In some examples, when plug alignment feature 42 is configured as electrical contract 40-6, electrical contact 40-6 may be arranged as a ground contact. It is noted that such arrangement/configuration of contacts 40-1 to 40-6 is intended to represent one example arrangement, and that other arrangements may be employed.

As illustrated schematically by FIG. 2D, in some examples, one or more of the concentric contacts 40-1 to 40-6 of charging plug 20, together with corresponding concentrically arranged contacts of EV charging port 30 (e.g., see FIGS. 3B, 4A, and 4B) may be employed to carry different voltages/signals during different charging operations. For example, in one case, concentric contacts, such as concentric contacts 40-1 and 40-3, may be employed to perform a 240 VAC charging operation for one EV may be employed to perform a 600 VDC (or another voltage level, such as 300 VDC) charging operation of another vehicle. In examples, as illustrated, the voltage applied to concentric contacts 40-1 and 40-3 is controlled by the charging station 10 via an arrangement of controllable contacts 44 situated within charging station 10 between selectable power supplies within the charging station (e.g., 240 VAC, 300 VDC, 600 VDC), such as power supplied 46a and 46b, and the concentric charging contacts 40-1 and 40-3. In examples, controller 16 of charging station 10 determines which charging voltage to provide/output (and which concentric charging contacts to employ) via communication with the EV 10 to be charged (e.g., via wireless communication, or wired communication via the charging cable 12 and charging plug 20). By multi-purposing one or more of concentric contacts 40 in such fashion, a total number of concentric contacts 40 for both the charging plug 20 and EV charging port 30 may reduced, thereby reducing the size of charging plug 20 and charging port 30, as well as reducing the amount of material/conductors required.

In examples, in addition to surface contacts 40-1 to 40-5 and alignment feature/contact 42/40-6, bottom surface 38 of charging plug 20 further includes a circumferentially extending locking magnet 48 which is configured to secure charging plug 20 to a corresponding circumferentially extending locking magnet of EV charging port 30 (see FIG. 4B). In some examples, locking magnet 48 may comprise a permanent magnet having a polarity opposite of a corresponding magnet of EV charging port 30. In other example, locking magnet 48 comprises an electromagnet which may be energized or de-energized and/or have its magnetic field strength dynamically controlled (increased or decreased) by controller 16 of charging station 10. In some examples, electromagnetic locking magnet 48 may initially be de-energized by controller 16 while charging plug 20 is being positioned over EV charging port 30, and upon charging plug 20 being aligned with EV charging port 30 (e.g., via a signal via control and/or proximity contacts 40-4 and 40-5) controller 16 energizes electromagnetic locking magnet 48 to magnetically draw charging plug 20 to EV charging port 30 and magnetically lock charging plug 20 thereto during a duration of a charging operation. In some examples, controller 16 of charging station 10 may reverse a current flow through electromagnetic locking magnet 48 in order to reverse its magnetic field to assist in removing charging plug 20 from EV charging port 30 upon completion of charging operation.

In some examples, alignment feature 42 may also comprise a magnetic alignment feature which is configured to be received within a corresponding magnetized indent of EV charging port 30 (see FIG. 4B), wherein a resulting magnetic force draws alignment feature 42 and the corresponding magnetic indent of EV charging port 30 and holds charging plug 20 in place. In one example, as described above, upon alignment feature 42 being positioned within the corresponding alignment indent of EV charging port 30, controller 16 of charging station 10 energized electromagnet locking magnet 48 to magnetically lock charging plug 20 to charging port 30 of EV 14. In some examples, alignment feature 42 and the corresponding alignment indent of EV charging port 30 are permanent magnets having opposite polarities. In some examples, alignment feature 42 and the corresponding alignment indent of EV charging port 30 comprise electromagnets. In some examples, alignment feature 42 and the corresponding alignment indent of EV charging port 30 are nonmagnetic.

In some examples, during an EV charging operation, magnetic alignment feature 42 and/or magnetic locking magnet 48 may be used for both aligning charging plug 20 with EV charging port 30 and for securing charging plug 20 to EV charging port 30. In one example, both alignment feature 42 and magnetic locking magnet 48 comprise electromagnets. In one example, as charging plug 20 is being positioned over and aligned with EV charging port 30, controller 16 may increase the magnetic field strength of magnetic alignment feature 42 and locking magnet 48 so as to better draw charging plug 20 into alignment with EV charging port 30 (via magnetic attraction between alignment feature 42 and locking magnet 48 and the corresponding alignment indent 72 and locking magnet 78 of EV charging port 30, see FIG. 4B). According to one example, once charging plug 20 is aligned with and secured to EV charging port 30, controller 16 may lessen the magnetic field strength of alignment feature 42 and locking magnet 48.

In one example, during an alignment procedure, controller 16 may initially energize electromagnetic alignment feature 42 and de-energize electromagnetic locking magnet 48. Once alignment feature 42 is seated within the corresponding alignment indent of EV charging port 30 such that charging plug 20 is aligned with EV charging port 30, controller 30 energized electromagnetic locking magnet 48 to secure charging plug 20 to EV charging port 30 and de-energizes alignment element 42 (or vice-versa, where locking magnet 48 is employed as an alignment magnet and alignment element 42 is employed as a locking magnet).

FIG. 3 is schematic cross-sectional view of charging plug 20, according to one example. In one example, main body 32 of charging plug 20 includes an inner body portion 32a and an outer body portion 32b disposed about inner body portion 32a, wherein inner body portion 32a and outer body portion 32b are moveable relative to one another. In one example, alignment feature 42 and circular contacts 40-1 to 40-5 are disposed on bottom surface 38a of inner body portion 32a and locking magnetic 48 is disposed on bottom surface 38b of outer body portion 32b. In one example, as illustrated, inner body portion 32a is biased so that bottom surface 38a with circular contacts 40-1 to 40-5 disposed thereon extends beyond bottom surface 38b of outer body portion 32b having locking magnet 48 disposed thereon, wherein bottom surface 38a of inner body portion 32a and bottom surface 38b of outer body portion 32b together represent bottom surface 38 of charging plug 20 (which is configured to contact a surface of EV charging port 30).

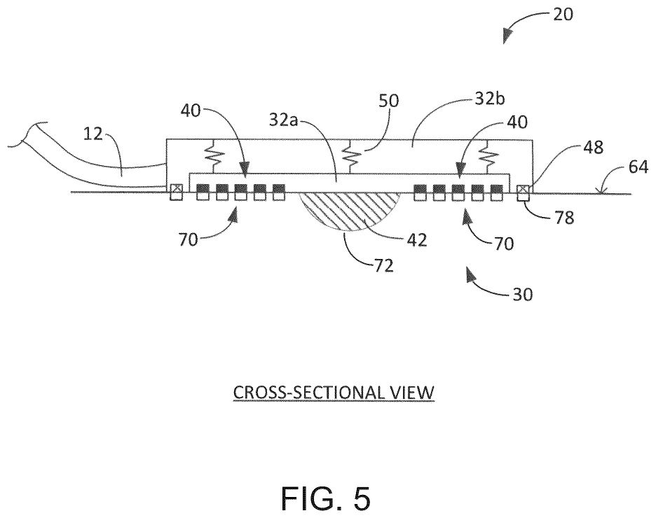

In one example, inner body portion 32a is biased away from outer body portion 32b using an elastic biasing mechanism, such as illustrated by biasing springs 50. In one example, as illustrated in greater detail below (e.g., see FIG. 5), when alignment feature 42 is properly seated within a corresponding alignment indent of EV charging port 30, electromagnetic locking magnet 48 is energized so as to be drawn to and magnetically lock onto to a corresponding locking magnet portion of EV charging port 30, which causes outer body portion 32b to be pulled into contact with EV charging port 30 and which, in-turn, causes inner body portion 32a to be biased against EV charging port 30 so that circular contacts 40-1 to 40-5 disposed thereon biased in tight contact with corresponding circular contacts of EV charging port 30 (see FIG. 5). In one example, as illustrated at 52, to ensure contact between circuit contacts 40-1 to 40-5 corresponding circular contacts of EV charging port 30, contacts 40-1 to 40-5 extend incrementally beyond surface 38a of inner body portion 32a. Similarly, locking magnet 48 may extend incrementally beyond surface 38b of outer body portion 32b.

FIGS. 4A and 4B generally illustrate schematic cross-sectional views of EV charging port 30, in accordance with one example of the present disclosure. In one example, as illustrated, charging port 30 includes a charging port door 60 which is operable between an open and closed positions to provide access through exterior surface 62 of EV 14 to an engagement surface 64. FIG. 4A illustrates charging port door 60 in a closed position, and FIG. 4B illustrates charging port door 60 in an open position which provides access to engagement surface 64 by charging plug 20 for a charging operation.

In examples, engagement surface includes a plurality of concentric circular contacts 70, illustrated as concentric contacts 70-1 to 70-5, disposed centrically about an alignment indent 72, where concentric EV contacts 70-1 to 70-5 and alignment indent 72 respectively correspond to concentric circular contacts 40-1 to 40-5 and alignment element 42 of charging plug 20. In one example, concentric contacts 70-1 to 70-5 of EV charging port 30 extend incrementally beyond engagement surface 62 to ensure contact with corresponding concentric contacts 40-1 to 40-5 of charging plug 20 of charging station 10.

EV charging port 30 further includes a concentrically disposed locking/alignment magnet 78 which is configured to align and engage with locking/alignment magnet 48 of charging plug 20 (where locking/alignment magnet 78 may incrementally extend beyond engagement surface 62. In one example, at least a portion of alignment indent 72 is magnetized, as indicated by magnet 74 in FIG. 4B. In examples, alignment indent magnet 74 and concentric locking magnet 78 may comprise permanent magnets, electromagnets, or any combination thereof. In examples, similar to that of alignment element 42 of charging plug 20, alignment indent 72 may also be configured as an electrical contact element 70-6 of EV charging port 30, such as an electrical ground contact, for example.

As described above, EV charging port 30 includes a charging port door 60 which is operable between a closed position and an open position. When in the closed position, as illustrated by FIG. 4A, charging port door 60 conceals and protects engagement surface 64, including concentric contacts 70 and alignment indent 72, from the exterior environment. When in the open position, as illustrated by FIG. 4B, charging port door 60 exposes engagement surface 64 of EV charging port 30 to the exterior environment to enable engagement surface 64 to receive and engage with charging plug 20 (as indicated by directional arrow 65) to perform a charging operation of battery 26 of EV 14. In one example, charging port door 60 is a sliding door that is controllable to slideably move back-and-forth between a closed position and an open position (as indicated by bi-directional arrow 61) where, when in the open position, charging port door 60 is disposed within a door pocket 66 behind exterior surface 62 of EV 14. In examples, charging port door 60 may be manually operated or electrically driven via controller 22 of EV 14. In one example, charging port door 60 includes a brush 68 which cleans any debris that may be present from concentric contacts 70 each time charging port door 60 slides between the open and closed positions.

FIG. 5 is schematic cross-sectional view generally illustrating charging plug 20 after being received by an attached to EV charging port 30, according to one example. An operation of connecting charging plug 20 with EV charging port is described by FIG. 5 together with further reference to FIGS. 3 and 4A/4B. In one example, during a connecting operation, controller 16 of charging station 10 energizes an electromagnet of alignment feature 42 of charging plug 20 such that an attractive magnet force is created by alignment feature 42 and magnet 74 of alignment indent 72 of EV charging port 30. In examples, magnet 74 comprises a permanent magnet having a magnetic field with a polarity opposite to that of alignment feature 42. In other examples, magnet 74 comprises an electromagnet which is energized by controller 22 of EV 14 during a charging operation to generate a magnetic field having a polarity opposite to that of the polarity of the magnetic field of alignment feature 42 to create an attractive force therebetween to attract alignment feature 42 to alignment indent 72. In other examples, alignment feature 42 of charging plug 20 is a permanent magnet and magnet 74 of alignment indent 72 is an electromagnet. In other examples, both alignment feature 42 of charging plug 20 and magnet 74 of alignment indent 74 comprise permanent magnets. In still other examples, neither alignment feature 42 nor alignment indent 72 are magnetic.

As bottom surface 38 of charging plug 20 is moved toward engagement surface 64 of EV charging port 30 (see directional arrow 65 in FIG. 4B), alignment feature 42 becomes seated within alignment indent 72, at which point a control signal (e.g., such as via circular contact 40-5 (proximity pilot)) is provided to controller 16 of charging station 10. With alignment feature 42 seated within alignment indent 72 of EV charging port 30, the plurality of concentric circular contacts 40 (e.g., 40-1 to 40-5) disposed concentrically about alignment feature 42 are automatically aligned with the corresponding plurality of circular contacts 70 (e.g., 70-1 to 70-5) disposed concentrically about alignment indent 72 engagement surface 64 of EV charging port 30 (or on an engagement surface of a port adapter employed with EV charging port 30).

In one example, upon receiving indication that charging plug 20 is properly positioned on engagement surface 62, controller 16 activates electromagnetic locking magnet 48 to create a magnetic field that pulls locking magnet 48 to locking magnet 78 to magnetically secure charging plug 20 to EV charging port 30. With locking magnet 48 magnetically coupled to locking magnet 78, biasing mechanism(s) 50 (e.g., elastic springs) are compressed and bias inner body portion 32a toward engagement surface 64 of EV charging port 30 so that concentric contacts 40 (e.g., 40-1 to 40-5) are biased against corresponding concentric contacts 70 (e.g., 70-1 to 70-5). In examples, a width (in a radial direction) of concentric circular contacts 70 of EV charging port 30 are greater than a width of the corresponding concentric circular contacts 40 of the charging plug 20 (or vice-versa) to ensure that an entire surface of each of the concentric circular contacts of charging plug 20 will be in contact with a corresponding one of the concentric circular contacts 70 of EV charging port 30.

In examples, upon charging plug 20 being magnetically locked to engagement surface 64 of EV charging port 30, controller 16 of charging station 10 carries out a charging operation to charge battery 26 of EV 14. In examples, indication that charging plug 20 is properly attached to EV charging port 30 may be made when one of the concentric contracts 40 of charging plug 20 completes an electrical circuit via contact with a corresponding concentric contact of EV charging port 30. In one example, as described above, upon completion of a charging operation, controller 16 of charging station 10 may reverse the magnetic field polarity of locking magnet 48 to ush charging plug 20 away from engagement surface 64 to disconnect charging plug 20 from EV charging port 30. In other examples, upon completion of a charging procedure, a user may press a release switch (not illustrated) disposed on body 32 of charging plug 20 to break the magnetic field of locking magnet 48 to release charging plug 20 from EV charging port 30.

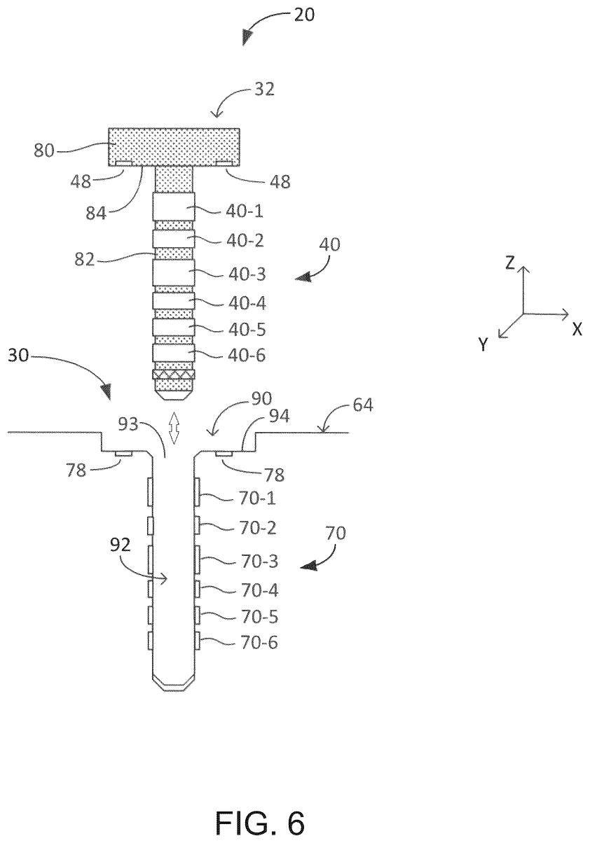

FIG. 6 is a block and schematic diagram generally illustrating an alternate implementation of charging plug 20 and corresponding EV charging port 30 using circular charging contacts, according to one example. In one example, main body 32 of charging plug 20 includes a head 80 and a shaft 82 longitudinally extending from a lower surface 84 of head 80. In one example, head 80 is disc-shaped (e.g., circular) with shaft 80 extending coaxially with a center axis of head 80. In other examples, head 80 may have shapes other than circular. In one example, circular contacts 40, indicated as circular contacts 40-1 to 40-6, have a ring-like form and extend about a perimeter surface of shaft 80, with contacts 40-1 to 40-6 being spaced along a length of shaft 82 to eliminate electrical arcing between adjacent contacts. In one example, locking magnet 48 is disposed on lower surface 84 of head 80 and extends circumferentially thereabout. In one example, a cleaning brush 86 extends circumferentially about a lower end of shaft 80.

EV charging port 30 includes a head recess portion 90 and a shaft recess portion 92 respectively have the negative shapes of head 80 and shaft 82 of charging plug 20. Shaft recess portion 92 includes circular contacts 70, indicated as circular contacts 70-1 to 70-6, have a ring-like shape and are disposed about the inner circumferential surface of shaft recess portion 92. In one example, locking magnet 78 is circumferentially disposed about an entrance 93 to shaft recess portion 92 on a surface 94 of head recess portion 90.

When charging plug 20 is inserted into EV charging port 30, shaft 82 is disposed within shaft recess portion 92 with contact rings 40-1 to 40-6 aligned with contact rings 70-1 to 70-6, and head 80 is disposed within head recess portion 90 with locking magnet 48 aligned with locking magnet 78. In examples, once positioned within EV charging port 30, controller 16 of charging station energized electromagnetic locking magnet 48 to magnetically secure charging plug 20 to EV charging port 30. Similar to the arrangement of charging plug 20 described above by FIGS. 2A-2D and 3, the circular configuration of the plurality of contact rings 40 and 70 of the arrangement of FIG. 6 eliminates the need for rotational alignment (e.g., about the z-axis in FIG. 6) of charging plug 20 and EV charging port 30, and thereby simplifies the overall process of attaching charging plug 20 to EV charging port 30.

Due to their configurations, charging plug 20 according to FIGS. 2A-2D may sometimes be referred to herein as a “charging paddle”, while charging plug 20 according to FIG. 6 may sometimes be referred to as a “charging stick” or “charging wand”.

### Hands-Free Charging System (Accessible Charging)

Due to the surface level and concentrically arranged magnetic and electric connections between the charging plug 20 and corresponding charging port 30 of electric vehicle 14, charging plug 20 and charging port 30, in accordance with the present disclosure, eliminate the need for rotational alignment between charging plug 20 and charging port 30, and require less force for connection than traditional male-female type plug connectors. Because of the ease of connection, charging plug 20 and charging port 30, in accordance with the present disclosure, provide improved accessibility for persons with physical limitations, including being particularly well-suited to enable hands-free connection of an EV charging station, such as EV charging station 10, to an EV, such as EV 14. Examples of hands-free charging systems may include EV charging stations, such as EV charging station 10, employing robotic means for connecting charging plug 20 to EV charging port 30 via robotic means. Such hands-free charging may be carried out with user input to charging station 10 via controller 22 of EV 14 (including through voice commands) or may be carried out automatically via communication between charging station 10 and EV 14 (e.g., wireless communication between controller 16 of charging station 10 and controller 22 of EV 14). Charging of EV 14 may be accomplished simply through use of voice commands or a software app, making charging of EV 14 available to almost anyone.

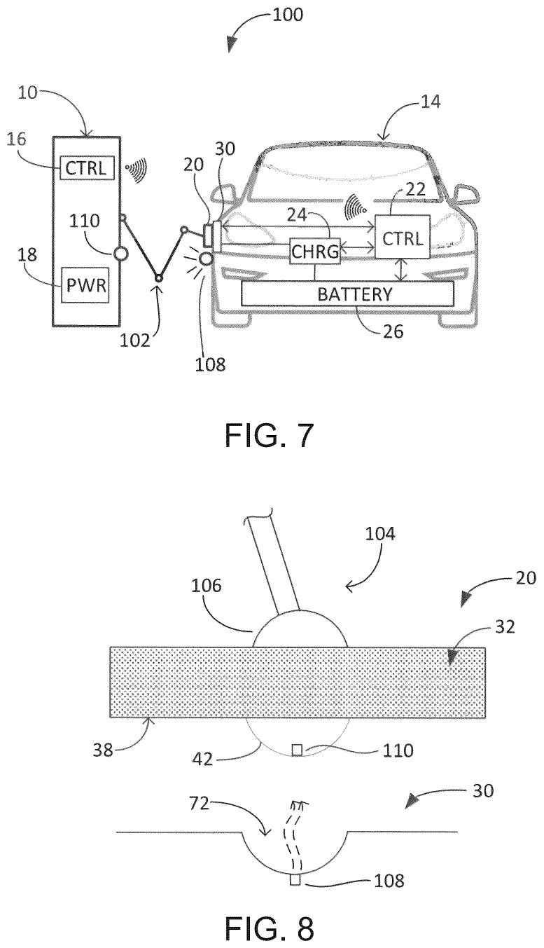

FIGS. 7 and 8 are block and schematic diagrams generally illustrating a hands-free EV charging system 100 employing a charging plug 20 and EV charging port 30 having concentrically arranged ring-like magnetic and electric surface contacts, according to one example. Referring to FIG. 7, hands-free charging system 100 includes EV charging station 10 including a charging plug 20 for use with EV 14 having charging port 30, in accordance with the present disclosure, such as illustrated by FIGS. 2A through 5. The arrangement of hands-free charging system 100 is similar to the charging system of FIG. 1, except that in lieu of charging plug 20 being connected to a flexible charging cable 12, charging cable 12 is replaced with an articulating robotic arm 102. In examples, charging plug 20 is disposed at the distal end 104 of robotic arm 102, wherein charging plug 20 can be moved 3-dimensionally in the x-, y-, and z-dimensions by robotic arm 102 under the direction of controller 16 of charging station 10.

In one example, as illustrated by FIG. 8, which is a schematic cross-sectional view generally illustrating portions of charging plug 20, EV charging port 30, and robotic arm 102, charging plug 20 is coupled to distal end 104 of robotic arm 102 via a pivot element 106 and is able to pivot about at least the x- and y-axes. For ease of illustration, concentric contacts 40 and 70 of charging plug 20 and EV charging port 30 are not shown in FIG. 8.

In examples, EV 14 includes an optical marker 108 disposed proximate to EV charging port 30 and at a location which is visible to an optical sensor 110 of charging station 10. In one example, as illustrated, optical marker 108 comprises a light emitting diode. In other examples, optical marker 108 may comprise a reflective tag. Any one of number of suitable types of detectable markers may be employed. In one example, with reference to FIG. 8, optical marker 108 may comprise a light emitting diode which is disposed within the alignment indent of EV charging port 30. In one example, with continued reference to FIG. 8, optical sensor 100 of charging station 10 may be disposed on bottom surface 38 of charging plug 20, such as part of alignment element 42, for example.

According to one example, to carryout a charging operation, controller 16 of charging station 10 and controller 22 of EV 14 establish a wireless communication link (e.g., via Bluetooth connection). Upon establishing that EV 14 has requested a charging operation, optical sensor 110 of charging station 10 searches for optical marker 108 of EV 14, such as light emitting diode (LED) 108. In one example, when optical marker 108 comprises an LED, upon establishment of a communication link with charging station 10 and requesting a charging operation, controller 22 illuminates LED 108. In one example, when LED 108 is disposed as part of charging port 30, upon establishing a communication link with charging station 10 and requesting that a charging operation be performed, controller 22 opens charging door 60 of charging port 30 (e.g., see FIGS. 4A and 4B) and illuminates LED 108. Based on the position of optical marker, controller 16 communicates to EV 14 whether EV charging port 30 is within range of articulating robotic arm 102. In one example, if within range, controller 16 provides indication to the driver of EV 14, either via controller 22 and a user interface of EV 14, or by illuminating an indicating light (not shown) on charging station 10. In one example, if not within range, controller 16 provides indication to the driver of EV 14, such as via controller 22 and a user interface of EV 14, of which direction the driver needs to move EV14 to place charging port 30 within range of charging plug 20 on articulating robotic arm 102.

In one example, upon indication being provided to EV 14 that charging port 30 is within range of robotic arm 102 and EV 14 is placed into a charging mode by controller 22, controller 16 of charging station 10 controls robotic arm 102 to align and place lower surface 38 of charging plug 20 on engagement surface 64 of charging port 30 with alignment feature 42 disposed within alignment indent 72. In examples, when optical marker 108 is disposed within alignment indent 72, controller 16 uses real-time feedback from optical sensor 110 in charging plug 20 adjust the position of robotic arm and charging plug 20. In examples, as described above, controller 16 and controller 22 may activate alignment magnets to aid in the alignment of charging plug 20 with EV charging port 30.

In examples, upon charging plug 20 being properly attached to EV charging port 30 (e.g., as confirmed via control signals transmitted between charging station 10 and EV 14 via robotic arm 102 and charging plug 20, controller 16 of charging station 10 activates locking magnet 48 to magnetically secure charging plug 20 to EV charging port 30. Controller 15 then carries out the request charging of battery 26 of EV 14. Upon completion of the requested battery charging operation (e.g., upon battery 26 reaching a requested charge level, such as 80%), controller 16 deactivates locking magnet 48 and controls robotic arm 102 to remove charging plug 20 from EV charging port 30 and retracts robotic arm 102 and charging plug 20 into a stowed position within charging station 10. In examples, controller 22 of EV 14 then returns the door of charging port 30 to a closed position. In examples, a transaction cost of the charging operation may be paid by the driver via a user interface of EV 14 (e.g., either wirelessly or via a wired connection prior to charging plug 20 being disconnected from EV charging port 30) or via an app on the driver's phone, for example.

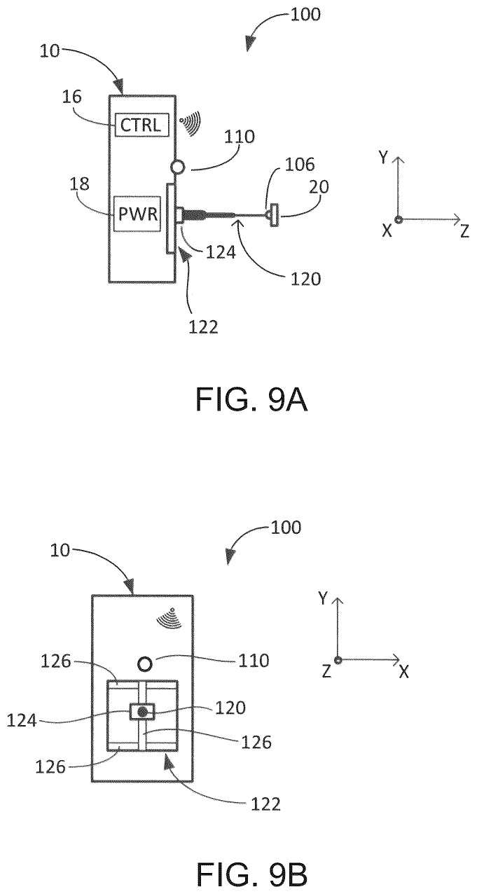

FIGS. 9A and 9B are block and schematic diagram generally illustrating an example of an alternative arrangement of hands-free charging system 100 where articulating robotic arm 102 is replaced with a telescoping arm 120 that can be electrically extended and retracted in the z-direction, and is operable to move in the x- and y-directions via a carriage system 122 which includes a carriage 124 that can be electrically driven (e.g., via solenoid motors) along a horizontal track (x-direction) 126 and a vertical track 128 (y-direction) to move telescoping arm 120 in the x- and y-directions. In examples, the operation of charging system 100 of FIGS. 9A and 9B to align and attach charging plug 20 to EV charging port 30 is similar to that described above with respect to charging system 100 of FIGS. 7 and 8. In one example, as illustrated, carriage 124 is driven along vertical track 128 to move telescoping arm 120 in the y-direction, and vertical track 128 is driven along horizontal tracks 126 to move telescoping arm 120 in the x-direction.

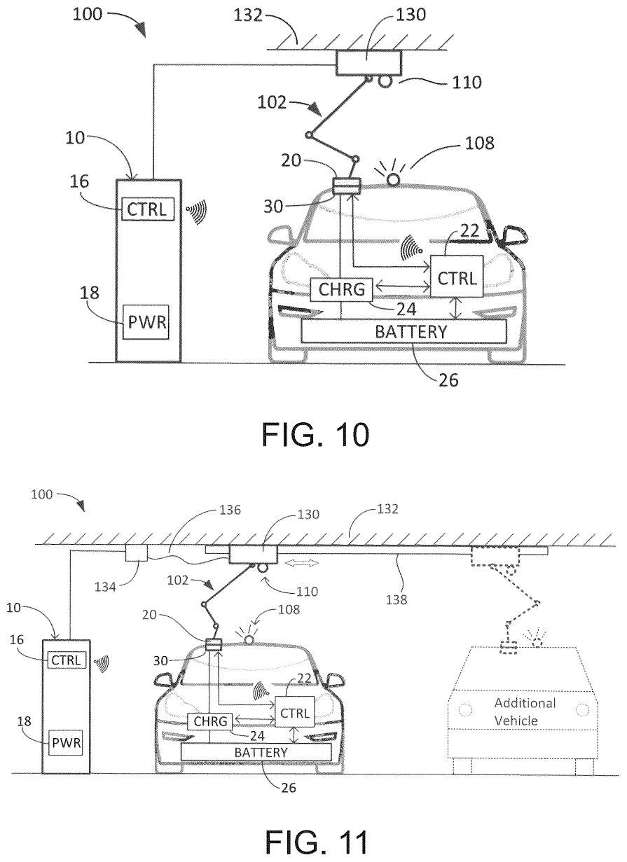

FIG. 10 is a block and schematic diagram generally illustrating hands-free charging system 100, according to one example, which is similar to that described and illustrated by FIGS. 7 and 8, except that rather than being mounted directly to charging station 10, articulating arm 102 is mounted to a carriage box 130 which, in-turn, is mounted to a ceiling structure 132, such as the ceiling structure of a residential garage. Additionally, in lieu of EV charging port 30 being disposed on a vertical surface of EV 14, charging port 30 is disposed on a horizontal surface of EV 14, such as on the roof, as illustrated (but other horizontal surfaces may be employed as well, such as the trunk or hood surface, for example). Also, although illustrated as being on a horizontal surface of EV 10, EV charging port 30 may also be installed on vertical surfaces, such as on the side of EV 10 (as illustrated by FIG. 7). A charging operation for hands-free charging system 100 of FIG. 10 may be similar to that described with respect to hands-free charging system 100 of FIGS. 7 and 8.

FIG. 11 is a block and schematic diagram illustrating hands-free charging system 100 of FIG. 10, except that charging system 100 of FIG. 11 is configured to enable charging of multiple EVs, such as two EVs, for example, which is a common situation encountered in residential garages. In the example implementation of FIG. 11, in lieu of being fixedly mounted to ceiling structure 132, carriage box 130 is mounted to a transport track 138 mounted to ceiling structure 132 and extending across parking spaces for multiple vehicles, such as two vehicles. In operation, carriage box 130 can be driven along transport track 138 to sequentially charge EV 14 and an EV 14-1 if present (illustrated in dashed lines in FIG. 11). In one example, carriage box 130 includes an internal motor to drive carriage box 130 along transport track 138 under the control of controller 16 of charging station 10. In one example, power and control outputs from charging station 10 extend in a hardwired fashion 135 to a junction box 134 mounted to ceiling structure 132, and in-turn, extend to carriage box 130 via a flexible connection 136 is moveable with (extends and retracts from carriage box 130) carriage box 130 as it moves along transport track 138. A charging operation for hands-free charging system 100 of FIG. 10 may be similar to that described with respect to hands-free charging system 100 of FIGS. 7 and 8.

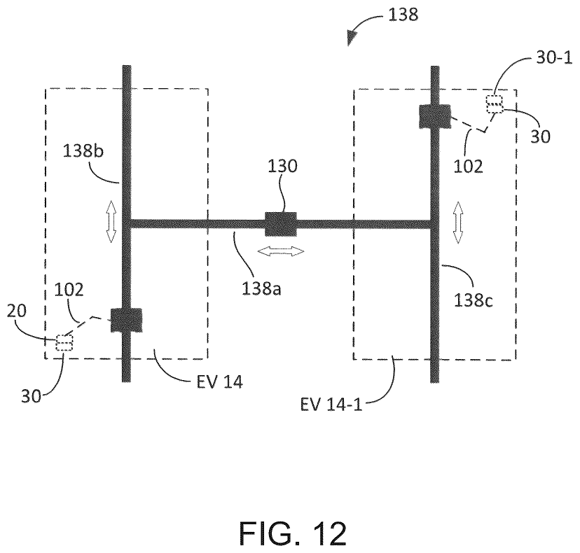

FIG. 12 is a schematic diagram generally illustrating an example arrangement layout for ceiling mounted transport track 138 (which may also be referred to as a charging track) for a residential garage having parking spaces for two EVs, indicated as EV 14 and EV 14-1. In one example, transport track 138 has a first section 138a that extends between the parking spaces for EV 14 and EV 14-1, a second section 138b that extends along the parking space for EV 14, and a third section 138c that extends along the parking space for EV 14-1. In examples, as illustrated, EV charging ports 30, illustrated at charging ports 30 and 30-1, may be disposed at different locations on EV 14 and EV 14-1. In operation, charging carriage 130 can be driven along second 138a through 138c as needed to position robotic arm 102 within a reachable range of charging ports 30 and 30-1. In other examples, transport track 138 may be extended to provide charging for more than two EVs. By employing a charging carriage 130 that be controllably driven along transport track 138 to multiple vehicle locations, charging system 100 of FIGS. 11 and 12 enables a single charging station 10 to provide charging for multiple EVs.

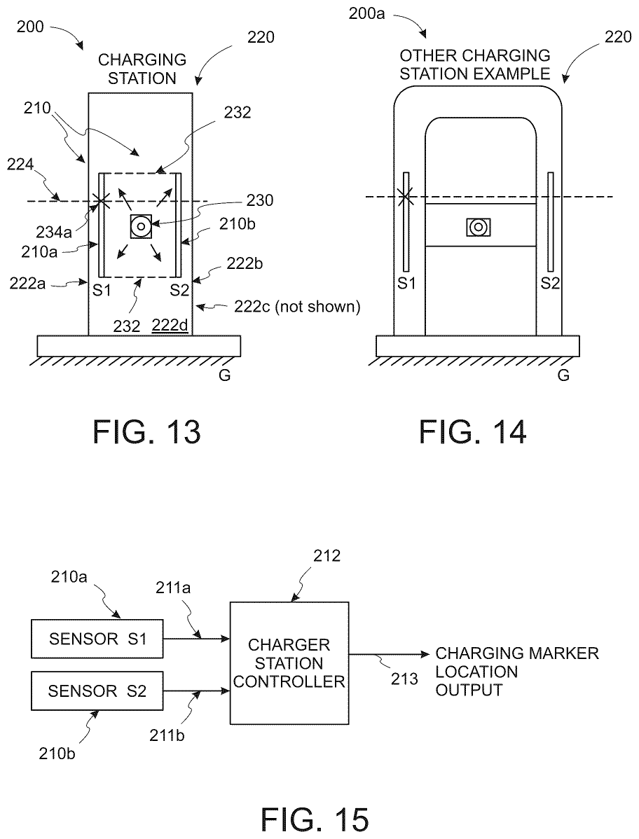

FIG. 13 is a diagram illustrating one example charging station generally at 200. The charging station 200 can be similar to charging stations detailed herein, and is suitable for use in handsfree charging of an electric vehicle. Changing station 200 includes sensors 210 to detect the location of a charging port for an electric vehicle requesting a charge. In one example, the sensors detect a charging marker associated with the electric vehicle. The charging port has a known position relative to the charging marker. In one example illustrated, the charging marker is located near the electric vehicle charging port. In other examples, the charging marker is located on the vehicle in a location away from the charging port.

The sensors 210 include a first sensor 210a and a second sensor 210b. The sensors 210a, 210b are optical sensors configured to sense an optical signal. Additionally, the sensors 210a, 210b are linear sensors positioned vertically on charging station 200. In one example, the electric vehicle requesting a charge includes a charging marker 215 (not illustrated in FIG. 13) that emits an optical signal (e.g., an LED). As the electric vehicle moves across the charging station into position for operably coupling to the charging station, the optical signal emitted from the charging marker moves across the optical sensors 210. The optical sensors 210 receive the optical signal from the electric vehicle charging marker and use it to aid in determining the location of the electric vehicle charging port.

In one example, the charging station 200 includes a housing 220. The housing 220 includes a vertically extending first side 222a, and a vertically extending second side 222b, a rear side 222c, and a front side 222d. The first sensor 210a is positioned on front side 222d, spaced inward from first side 222a. The second sensor 210b is positioned on front side 222d, spaced inward from second side 222b. The first sensor 210a is a linear extending optical sensor, positioned vertically on front side 222a and generally orthogonal to the ground G. The second sensor 210b is a linear extending optical sensor positioned vertically on front side 222a and generally orthogonal to ground G.

The charging station 200 includes a charging arm 230 similar to a charging arm and paddle previously detailed herein. The charging paddle 230 couples to the electric vehicle during a charging operation. The charging arm 230 is movable three dimensionally for coupling to the electric vehicle charging port. In one example, the charging arm 230 is a telescoping arm, and includes a charging paddle and a gimbal base allowing for multiple degrees of freedom of movement. In one example, the telescoping arm is a cylindrical telescoping arm. In another example, the telescoping arm has a telescoping tray configuration. The telescoping tray configuration includes a charging paddle positioned on telescoping tray side rails.

In one example, the charging station 200 includes a charging window 232. When the electric vehicle charging marker is positioned within the charging window, the electric vehicle charging port is in position for automatically coupling to the charging port for a charging operation. The charging window 232 is defined by the area on the charging station front side 222d between the first sensor 210a and the second sensor 210b. Additionally, the charging paddle 230 is operably located proximate to the charging window 232. In one example, the charging paddle is located on the charging station 200 within the charging window 232.

When moving into a charging position, the electric vehicle charging marker moves along an optical path 224 across the charging station 200. This optical path 224 is a generally horizontal optical path relative to ground G. As such, the optical path 224 of the charging marker is registered on the optical sensors 210 as it crosses at 234a the sensors 210 and moves into changing position within charging window 232, also allowing the charging station 200 to determine the general horizontal location of the charging marker and whether the electric vehicle is in position for electrically coupling to the charging station 200.

In other examples, the charging marker can be positioned at other locations on the electric vehicle. The charging marker can be optical, audio, digital, or provide another type of signal to the charging station to aid the charging station in determining its location.

FIG. 14 is a diagram illustrating another charging station example at 200a. Although the charging station 200a has a different configuration than charging station 200, the charging station 200a operates in a manner similar to the charging station 200 detailed herein.

FIG. 15 is a block diagram illustrating one example of charging station 210 having a positioning system 236 for determining whether the charging marker 232 is in the charging window 232. The system 236 includes sensor 210 in communication with charging station controller 212, and sensor 210b in communication with charging station controller 212. When the charging marker light output moves along optical path 224 and crosses sensor 210a, controller 212 is notified via output signal 211a. Additionally, since sensor 210a is a linear sensor, output signal notifies controller 212 that the charging marker is in the charging window 232 and the height (i.e., vertical location) relative to ground G of the charging marker. Controller 212 can provide a charging marker location output signal representative of the horizontal location of the charging marker within charging window 232. If the charging marker also crosses sensor 210b, sensor 210b output signal 211b notifies controller 212 that the charging marker is outside of the charging window 232. The electric vehicle is notified by the charging station controller 212 that they must back up to locate within the charging window. The controller 212 is again notified that the charging marker is within the charging window 232 when the charging marker again crosses the sensor 210b.

Once the charging marker is located within the charging window 232, the controller 212 operates to determine the exact location of the charging marker. In one example, the exact location of charging marker 215 is determined using charging scanner 216.

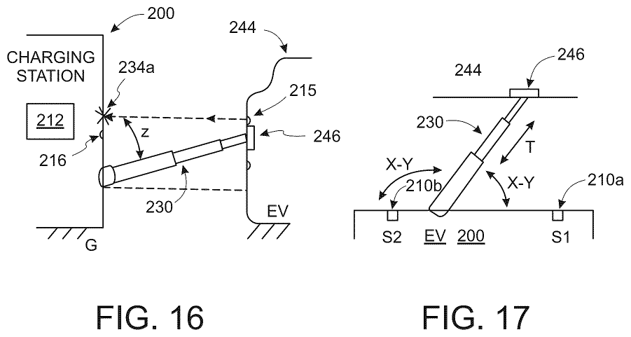

FIG. 16 is a side view of charging arm 230 electrically coupled to charging port 246. In one example, the charging arm 230 is electromagnetically coupled to charging port 246. charging marker 215 is positioned within the charging window 232.

FIG. 17 is a top view of charging arm 230 electrically coupled to charging port 246. Charging arm 230 includes a gimbal base 231 for free movement of the charging arm 230 in a three dimensional plane (e.g., X, Y, and Z plane).

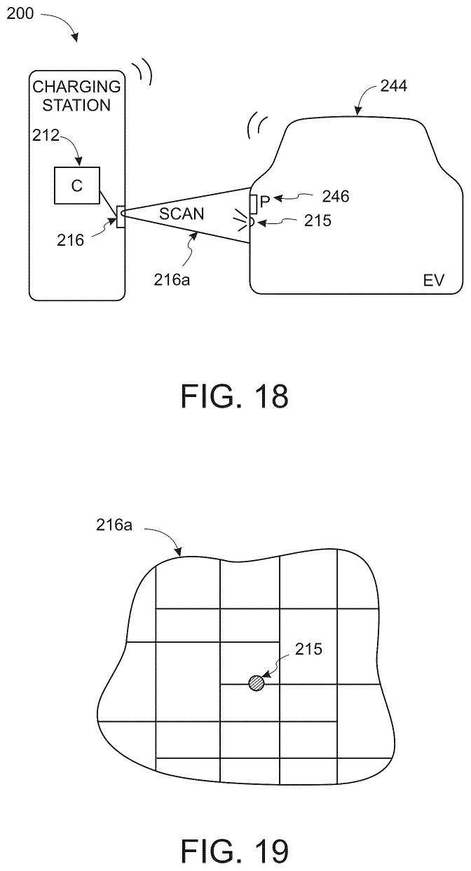

FIG. 18 is a diagram illustrating one example of charging station 200 including a location system for determining the exact location of charging port 246. The charging station 200 includes scanner 216 coupled to controller 212. Once the electric vehicle 244 charging port 246 is in charging proximity (e.g., close enough for the charging station to charge couple to the charging port) to charging station 200 (e.g., using location sensors 210 described herein), scanner 216 determines the exact location of charging marker 215. Charging marker 215 has a predetermined and defined precise location relative to charging port 246. Electric vehicle 244 communicates the exact location (e.g., three dimensional, gps, or other coordinates) of the charging port 246 relative to the charging marker 215. With the charging port 246 location known, controller 212 operates the charging arm 230 to charge couple to the charging port 246 and charge the electric vehicle 244.

FIG. 19 is a diagram illustrating one example of the operation of scanner 216. In one example, scanner 216 is a capture scanner. The scanner 216 projects a scanner grid 216a at charging marker 215, and locks in on charging marker 215 determining the location of the charging marker. In one example, the scanner 216 uses a laser or LED to shine a red light on a charging marker and illuminates a code. The scanner's sensor then detects the light that is reflected back into it, and generates an analog signal that is sent to a decoder at the controller 212. The decoder interprets the signal, validates the code, and converts it into a defined location with coordinates relative to the arm 230.

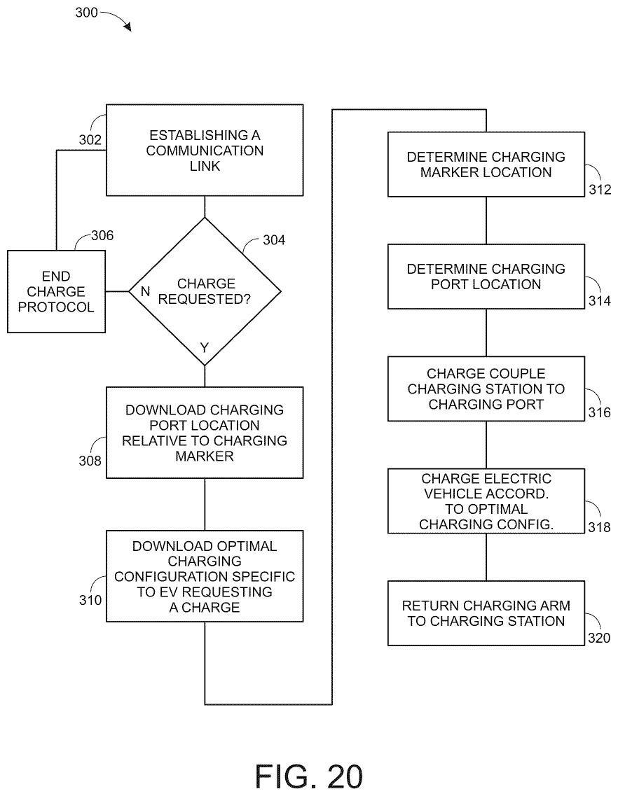

FIG. 20 is a flow diagram illustrating one example of a method 300 of charging an electric vehicle using a charging marker. The charging method is easily used for hands-free, accessible charging of an electric vehicle. At 302, a communication link is established between the charging station and the electric vehicle requesting a charge. In one or more examples, the communication link is a wireless communication link. At 304, the charging station determines whether a charge is being requested. At 306, if a charge is not being requested, the charge protocol is ended. The charging station continues to monitor if the electric vehicle requests a charge.

At 308, if it is determined a charge is requested by the electric vehicle then the charging port location is communicated to the charging station. In one example, the charging port location relative to the charging marker is downloaded and communicated from the electric vehicle to the charging station. At 310, other charging information relative to the electric vehicle and user requesting a charge is communicated to the charging station. In one example, the optimal charging configuration specific to the electric vehicle requesting a charge is communicated to the charging station.

At 312, the charging station determines the location of the charging marker. At 314, using the charging marker location the charging station determines the location of the charging port relative to the charging marker.

At 316, the charging station charge couples the charging station to the charging port. In one example, the charging arm is electromagnetically coupled to the charging port. At 318, the electric vehicle is charged according to the other charging information including the optimal charging configuration. At 320, once charging of the electric vehicle is complete the charging arm is returned to the charging station.

In examples, an electric vehicle charging system with a magnetic charging plug and EV charging port having concentrically arranged magnetic and electric surface contacts may include a combination of one or more of the following features:

### Electromagnetic Plug and Magnetic Charging Port

Electromagnetic plug connection to charging port and/or to charging station dock. Electromagnetic plug may include a protruding alignment feature configured to received within a corresponding alignment indent of an electric vehicle charging port

Can use magnetics to self-align the plug connection to electric vehicle.

Electromagnetic plug with switch. Electromagnetic plug can include a switch (e.g., rocker switch) to shut off magnetics. For example, can switch off when done charging or when removing charging plug from charging station dock.

Electromagnetic Alignment/Coupling. Electromagnetic alignment and/or coupling can be “switched off” or “released” by reversing the current flow to one or more electromagnets on the plug.

Electromagnetic charging plug and EV charging port may have concentrically arranged circular charging contacts disposed on corresponding surfaces to eliminate the need for radial alignment there between.

Magnetic Port Surface. Could be a smooth surface or have a tapered indent configuration to act as a plug connection guide.

Magnetic Port Locations. Could locate in a number of spots on an electric vehicle. Could be located on back side of side mirrors. Could be located near the headlights. Could be on the roof of the vehicle.

Magnetic Alignment System. The magnetic plug can include a magnetic alignment system for aligning the magnetic plug with an electric vehicle charging port.

Magnetic Coupling System. The magnetic plug can include a magnetic coupling system for coupling the magnetic plug to an ev charging port during a charging operation.

Dual Magnetic Plug System. The Magnetic Plug System can include both a plug magnetic alignment system and a plug magnetic coupling/locking system. In one example, the plug magnetic alignment system comprises a set of magnets located about an (outer) edge configured to aid in aligning the magnetic plug on an ev charging port. The magnetic coupling system comprises a set of magnets located on the charging plug to securely couple the charging plug to an ev charging port during charging of the ev. The magnetic coupling system can also be located about an outer edge of the charging plug.

Electromagnetic Systems. The magnetic alignment system and the magnetic plug system can be electromagnetic systems.

An Electric Vehicle have a Charging Port with a Sliding Door and/or Self Cleaning Door

EV Charging Port can have a sliding charging port door.

Sliding door can slide under or above the exterior of electric vehicle.

In one example, a sliding door slides into a sliding door pocket.

Door can be electrically or manually slid open or closed.

Door can be electrically open or closed via control of a corresponding electro door motor.

Can be locally controlled or remotely controlled. For example, it can be controlled from inside the electric vehicle, from an app or computer, or controlled via the charging station.

Exterior side of the sliding door protects the charging port charging surface from exterior elements.

Interior side of the sliding door faces the charging contact surface.

In one example, the sliding door provides self cleaning of the charging port.

Interior side of the sliding door includes a cleaning element layer. Each time the sliding door is opened or closed, the cleaning element layer cleans the charging port, and in particular, cleans the charging port contact surface.

In one or more examples, the cleaning element layer includes one or more of a brush layer, or a cleaning material layer (e.g., a micro cleaning material (such as a glass cleaner) or other cleaning material such as a suede material. In one or more examples, the cleaning element layer can be coated with a cleaning chemical to improve cleaning of the ev port surface. Example cleaning chemical materials include materials that improve adhesion of particles to cleaning element layer or materials that clean/polish port surface or materials that aid in dissolving or breaking down material (e.g., dust, dirt, grime, grease, etc.) on the charging port surface.

In one example, the sliding door slides into pocket when the ev port sliding door is slid open. The sliding door pocket or interior of the sliding door area when slid open includes a brush later or cleaning layer for cleaning the sliding door cleaning element layer when the sliding door is slid open or closed.

### Plug Operation

Two Step Process. In one example, the magnetic plug system is a two step system. First, an electromagnetic alignment system is activated for alignment of the magnetic plug system with the ev port. Once aligned, the electromagnetic coupling system is activated for coupling the magnetic plug system to the ev charging port to perform a charging operation. Once magnetically coupled together, the magnetic alignment system can continue to be activated or can be deactivated. Once the vehicle completes a charging operation (is charged to a desired level), the magnetic coupling system (and magnetic alignment system) can be selectively deactivated and/or the direction of the electromagnetic current can be reversed to release the magnetic coupling.

Two Mode Operation. In one example, the electromagnetic plug has a dual mode operation. The first mode is an alignment mode where the electromagnetic plug aligns (e.g., automatically aligns) with an ev charging port using at least one pair of electromagnets. Once aligned, the charging plug second mode is activated where the plug is electromagnetically coupled to the charging port during a charging operation.

In one example, the first alignment mode is a higher powered mode than the second coupling mode, allowing the charging plug to be snap fit aligned to the charging port. In the alignment mode, fewer electromagnets are activated than in the coupling mode but at a higher power to aid in alignment on the charging port.

Magnetic Plug System Control. The magnetic plug system can be controlled via the charging station, including the charging station or charging system control system.

Plug Alignment System. The plug alignment system can include both magnetic alignment components and physical alignment components to aid and assure proper alignment of the charging plug with an ev charging port.

Alignment Electromagnets can be Dual Purpose. The alignment electromagnets can also be used in the coupling mode. In one example, when the alignment electromagnets are used in the coupling mode they are operated at a different power level than during the alignment mode (e.g., a reduced power level).

Heater. Plug can include heated plug design. EV Charging port can be heated. Can be temperature activated for use in harsh winter conditions to avoid freezing rain and snow issues.

Shutoff System. Electromagnetic Plugs can be shut off via software, or can include a physical switch to shut off magnetics. For example, a rocker switch could shut off magnetics when removing a plug from a charging port.

### Plug Design Options

In one example, the charging plug includes electro magnets and the ev charging port includes permanent magnets or ferris material.

The ev charging plug can be circular shaped, or it can take on a number of other shapes such as being oval shaped or square shaped.

Plug shape. In one example, the charging port has a flat, smooth surface. In other examples, the charging port includes a semi-conical shaped or other shaped outer edge to act as a guide for aligning the charging plug with the charging port.

Electromagnet locations. Electromagnets used for alignment and/or coupling can be located near an outer edge of a charging plug, near the center of the charging plug, or both. The location of the electromagnets used for alignment and coupling correspond to the location of magnets (electromagnets or more probably a ferromagnetic material) on the charging port.

Plug magnets. The plug magnetics can take on a number of shapes and configurations. In one or more examples, the plug magnets are circular shaped, semi-circular shaped, oval shaped, or linear shaped. In another example, each “plug magnet” is made up of multiple smaller magnets. The end of multiple magnets are positioned together to form a plug magnet much stronger than a single magnet. EV charging port magnets can be configured in a similar manner.

EV Charging System with Magnetic Plug Adapter and/or Port Adapter

Magnetic Plug Adapter. A magnetic plug adapter can be used to convert an existing physical charging station plug to a magnetic plug for electro magnetic coupling to an ev.

Magnetic Plug Adapter Configuration. In one example, the magnetic plug adapter has a first side configured to physically plug into the charging plug, and has a second side configured to electromagnetically couple to an ev charging port.

EV Magnetic Port Adapter. An ev magnetic port adapter can be used to convert an existing physical ev charging port to a magnetic charging port for electromagnetic coupling to a charging station.

EV Magnetic Port Adapter Configuration. In one example, the ev magnetic port adapter includes a first side that physically couples to the charging port pins, and a second side for magnetically coupling to a magnetic charging plug of a charging station. In one example, the Port Adapter includes a contact layer, a plug connection layer, and a distribution layer. The contact layer can include permanent magnets. For example, the contact layer can include alignment magnets and coupling magnets that align with a charging plug. The plug connection layer is configured to match/couple the adapter to the ev port pins. The distribution layer provides electrical communication between corresponding elements in the contact layer and the plug connection layer.

In examples, an electric vehicle charging system with a vehicle charging marker may include a combination of one or more of the following features:

EV Charging System with Vehicle Charging Marker

A Charging Marker that is associated with an electric vehicle. The charging marker can be in the form of a visual, mechanical or other type of marker. In one example, the charging marker communicates with the charging system the location of the charging port on the vehicle.

The charging marker can be used as a reference point for the electric vehicle charging port. One or more charging markers can be located on an electric vehicle.

In one example, the charging marker is a visual marker (e.g., an LED marker). In one example, the charging marker is a physical marker. For example, when the vehicle is pulled into a charging location a physical on the bottom of the vehicle could be identified or grabbed by the charging system. The charging port is located relative to the charging marker. In one example, the charging marker is another type of marker, such as a QR code or bar code that provides a link to information of the charging configuration of the vehicle.

Charging marker can be used to communicate many types of charging configuration information associated with the vehicle for optimal charging of the vehicle. In one example, the charging marker communicates an exact port location on the vehicle. In one example, the charging marker communicates specific vehicle charging configuration.

Once a charging station communicates with the vehicle or locks on the charging marker, based on the make/model of the vehicle the charging station has access to data associated with the charging configuration of the vehicle such as the charging port.

In one example, the charging station includes a vertical bar/line sensor located at a front/edge of the charging station. When a vehicle requests a charge, the port sensor is activated. Additionally, a communication link between the vehicle and the charging station is activated (e.g., a Bluetooth or low energy communication link). At that time, the vehicle requesting a charge can communicate the vehicle charging configuration with the charginging station for optimal charging of the vehicle. When the vehicle approaches the charging station, the ev/charging port LED crosses the vertical bar sensor. The vertical bar sensor determines the presence of the vehicle, and also the (exact) height of the vehicle charging marker (e.g., an LED charging marker). Other sensors can also be used for determining the horizontal location of the charging marker. At that time, the charging station can determine the exact location of the charging port since the exact position of the charging port is defined relative to the LED charging marker.

In another example, an additional second vertical bar sensor is located at the distant side of the charging station as the vehicle approaches the charging station. If the LED charging marker is sensed by the vehicle getting in position for a charging event, the electric vehicle is notified that the EV is positioned too far for the charging station charging plug to automatically couple with the electric vehicle charging port. The electric vehicle is able to back up and once again bring the vehicle into charging range for a charging event.

Can use a capture device located on the charging station (similar to a grocery checkout station) to determine the exact location of LED charging marker and subsequently the ev charging port.

The charging marker can be located on a side, front, back, or near or on the bottom of an electric vehicle.

The charging marker can be a physical, virtual, or visual reference point used to determine the exact location of the electric vehicle charging port or can be used for locating another charging element.

It is recognized that the charging system including a charging marker of the present disclosure can be configured for use in many charging system applications, including those not disclosed herein.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

The claims are part of the specification.

1. An electric vehicle charging system, method, and charging marker as disclosed herein and equivalents.

2. An electric vehicle charging system comprising:
a charging marker having one or more features as disclosed herein, including being configured to aid in determining a charging port location for charging an electric vehicle.

3. The electric vehicle charging system of claim 2, comprising a charging station in communication with the charging marker, including a system for locating the charging marker.

4. An accessible electric vehicle charging system suitable for automatic hands-free charging as disclosed herein and equivalents.

5. The charging system of claim 4, where charging is accomplished via voice commands.

6. The charging system of claim 4, comprising a charging marker associated with the electric vehicle requesting a charge.
